(19) United States
(12) Patent Application Publication
(10) Pub. No.: US 2024/0209187 A1
(43) Pub. Date: Jun. 27, 2024

(54) RUBBER COMPOSITION FOR TIRE TREAD AND PNEUMATIC TIRE USING THE SAME

(71) Applicant: Toyo Tire Corporation, Itami-shi (JP)

(72) Inventors: Yousuke Nishio, Itami-shi (JP); Yugo Sumino, Itami-shi (JP)

(73) Assignee: Toyo Tire Corporation, Itami-shi (JP)

(21) Appl. No.: 18/530,595

(22) Filed: Dec. 6, 2023

(30) Foreign Application Priority Data
Dec. 23, 2022 (JP) 2022-206503

(51) Int. Cl. C08L 7/00; B60C 1/00; B60C 11/00; C08L 9/00

(52) U.S. Cl. CPC C08L 7/00; B60C 1/0016; B60C 11/0008; C08L 9/00; B60C 2011/0025; C08L 2205/03

(57) ABSTRACT

Provided is a rubber composition for a tire trend, including, per 100 parts by mass of a solid diene rubber including 45 to 55 parts by mass of an isoprene-based rubber and 45 to 55 parts by mass of a butadiene rubber, 50 parts by mass or more of silica, 7 to 20 parts by mass of a hydrocarbon-based resin, and 5 to 20 parts by mass of a modified liquid butadiene rubber.

### BACKGROUND OF THE INVENTION

### 1. Field of the Invention

The present invention relates to a rubber composition for a tire tread and also to a pneumatic tire using the same.

### 2. Description of Related Art

For rubber compositions used in tires, there is a need to improve grip performance on wet road surfaces (wet grip performance) and grip performance on frozen road surfaces (on-ice braking performance).

In order to address such a problem, in WO2018/131694, as a rubber composition having excellent on-ice performance, wet grip performance, low heat generation properties, and abrasion resistance, a rubber composition containing a natural rubber and a modified butadiene rubber terminated with a polyorganosiloxane group is described. However, there still has been room for improvement regarding on-ice braking performance.

### SUMMARY OF THE INVENTION

In view of the above points, an object of an aspect of the invention is to provide a rubber composition for a tire tread, which allows for an improvement in on-ice braking performance while maintaining or improving wet grip performance.

The invention includes the following embodiments.
[1] A rubber composition for a tire tread, including, per 100 parts by mass of a solid diene rubber including 45 to 55 parts by mass of an isoprene-based rubber and 45 to 55 parts by mass of a butadiene rubber, 50 parts by mass or more of silica, 7 to 20 parts by mass of a hydrocarbon-based resin, and 5 to 20 parts by mass of a modified liquid butadiene rubber.
[2] The rubber composition for a tire tread according to [1], in which the modified liquid butadiene rubber is a silane-modified liquid butadiene rubber.
[3] The rubber composition for a tire tread according to [1] or [2], having a storage modulus of 20 MPa or less as measured at −25° C.
[4] The rubber composition for a tire tread according to any one of [1] to [3], in which the temperature at peak tan δ is −45° C. or less, and the value of tan δ at 0° C. is 0.16 or more.
[5] A pneumatic tire made using the rubber composition according to any one of [1] to [4] for a tread.

According to a rubber composition for a tire tread of an aspect of the invention, it is possible to improve on-ice braking performance while maintaining or improving wet grip performance.

### DESCRIPTION OF EMBODIMENTS

Hereinafter, matters relevant to the practice of the invention will be described in detail.

A rubber composition for a tire tread according to this embodiment includes, per 100 parts by mass of a solid diene rubber including 45 to 55 parts by mass of an isoprene-based rubber and 45 to 55 parts by mass of a butadiene rubber, 50 parts by mass or more of silica, 7 to 20 parts by mass of a hydrocarbon-based resin, and 5 to 20 parts by mass of a modified liquid butadiene rubber.

As used herein, “solid” refers to having no fluidity at 23° C., and “liquid” refers to having fluidity at 23° C.

The solid diene rubber may consist of an isoprene-based rubber and a butadiene rubber, but may further incorporate other rubber components such as styrene butadiene rubber (SBR), nitrile rubber (NBR), chloroprene rubber (CR), butyl rubber (IIR), styrene-isoprene copolymer rubber, butadiene-isoprene copolymer rubber, and styrene-isoprene-butadiene copolymer rubber, for example, as long as the original effect is not impaired.

As isoprene-based rubbers, for example, natural rubber (NR), isoprene rubber (IR), and the like can be mentioned.

The rubber composition according to this embodiment contains silica as a reinforcing filler. Silica is not particularly limited, and, for example, wet silica such as wet-precipitated silica or wet-gelled silica may be used.

The silica content is, per 100 parts by mass of the solid diene rubber, 50 parts by mass or more, preferably 50 to 100 parts by mass, more preferably 50 to 90 parts by mass, and still more preferably 50 to 80 parts by mass. When the silica content is within the above range, excellent on-ice braking performance is easier to obtain.

As the reinforcing filler, in addition to silica, carbon black may also be used together. The reinforcing filler content (the total amount of silica and carbon black) is, per 100 parts by mass of the solid diene rubber, preferably 50 to 140 parts by mass, more preferably 50 to 120 parts by mass, and still more preferably 50 to 90 parts by mass. The carbon black content is, per 100 parts by mass of the solid diene rubber, preferably 0.1 to 40 parts by mass, more preferably 1 to 30 parts by mass, and still more preferably 1 to 20 parts by mass.

The rubber composition according to this embodiment preferably contains a silane coupling agent. In that case, the silane coupling agent content is, per 100 parts by mass of silica, preferably 1 to 20 parts by mass, and more preferably 1 to 15 parts by mass.

The hydrocarbon-based resin content is, per 100 parts by mass of the solid diene rubber, 7 to 20 parts by mass, preferably 7 to 15 parts by mass. When the hydrocarbon-based resin content is within the above range, excellent on-ice braking performance is easier to obtain.

As hydrocarbon-based resins, styrene-based resins, terpene-based resins, petroleum-based hydrocarbon resins, rosin-based resins, and the like can be mentioned. Among them, petroleum-based hydrocarbon resins and terpene-based resins are preferable.

A styrene-based resin may be a resin containing styrene and/or α-methylstyrene as a constituent monomer, and examples thereof include homopolymers obtained by polymerizing styrene or α-methylstyrene alone, copolymers obtained by copolymerizing styrene and α-methylstyrene, and copolymers of styrene and/or α-methylstyrene with other monomers. As other monomers, for example, terpene compounds such as α-pinene, β-pinene, dipentene, limonene, myrcene, alloocimene, ocimene, α-phellandrene, α-terpinene, γ-terpinene, terpinolene, 1,8-cineole, 1,4-cineole, α-terpineol, β-terpineol, and γ-terpineol (terpene-based monomers), non-conjugated olefins such as ethylene, propylene, 1-butene, 1-pentene, 1-hexene, 1-heptene, and 1-octene, and the like can be mentioned. One of them may be used alone, and it is also possible to use two or more kinds together.

A terpene-based resin is a resin whose raw material is at least one member selected from terpene compounds. As terpene compounds, for example, α-pinene, β-pinene, 3-carene (δ-3-carene), dipentene, limonene, myrcene, alloocimene, ocimene, α-phellandrene, α-terpinene, γ-terpinene, terpinolene, 1,8-cineole, 1,4-cineole, α-terpineol, β-terpineol, γ-terpineol, and the like can be mentioned. Terpene-based resins composed of these terpene compounds may be modified (e.g., phenol modification, aromatic modification, hydrocarbon modification, etc.) into modified terpene-based resins (e.g., terpene phenol-based resins, styrene-modified terpene-based resins, aromatic modified terpene-based resins, etc.).

As petroleum-based hydrocarbon resins, for example, C5-based aliphatic hydrocarbon resins, C9-based aromatic hydrocarbon resins, and C5/C9-based aliphatic/aromatic copolymerized hydrocarbon resins can be mentioned. An aliphatic hydrocarbon resin is a resin obtained by cationically polymerizing an unsaturated monomer such as isoprene or cyclopentadiene, which is a petroleum fraction equivalent to 4 to 5 carbon atoms (C5 fraction), and may be partially hydrogenated. An aromatic hydrocarbon resin is a resin obtained by cationically polymerizing a monomer such as vinyltoluene, an alkylstyrene, or indene, which is a petroleum fraction equivalent to 8 to 10 carbon atoms (C9 fraction), and may be partially hydrogenated. An aliphatic/aromatic copolymerized hydrocarbon resin is a resin obtained by copolymerizing the above C5 and C9 fractions by cationic polymerization, and may be partially hydrogenated.

As rosin-based resins, for example, rosins including raw material rosins such as gum rosin, wood rosin, and tall oil rosin, disproportionated products of raw material rosins, polymerized rosins, etc., esterified products of rosins (rosin ester resins), phenol-modified rosins, rosins modified with an unsaturated acid (maleic acid, etc.), formylated rosins obtained by reduction-treating rosins, and the like can be mentioned.

The modified liquid butadiene rubber content is, per 100 parts by mass of the solid diene rubber, 5 to 20 parts by mass, more preferably 5 to 15 parts by mass.

The modified liquid butadiene rubber is not particularly limited and may be one modified with a silane modifying group, such as an alkoxysilane group, in the molecular chain or at the molecular end. That is, the liquid butadiene rubber may be a silane-modified liquid butadiene rubber. Commercially available liquid butadiene rubbers can also be used, and, for example, “RICON 603” manufactured by Cray Valley and the like can be mentioned.

The weight average molecular weight of the modified liquid butadiene rubber is not particularly limited, but is preferably 1,000 to 100,000, and more preferably 1,000 to 50,000. Here, the weight average molecular weight of a modified liquid butadiene rubber is measured by gel permeation chromatography (GPC), and is a polystyrene-equivalent value calculated using a commercially available standard polystyrene at a measurement temperature of 40° C., a flow rate of 1.0 mL/min, a concentration of 1.0 g/L, and an injection volume of 40 μL using a differential refractive index detector (RI) as the detector, “TSKGel SuperHZM-M” manufactured by Tosoh Corporation as the column, and THE as the solvent.

In addition to the above components, the rubber composition according to this embodiment can incorporate various additives generally used in rubber compositions, such as zinc oxide, stearic acid, antioxidants, waxes, oils, vulcanizing agents, and vulcanization accelerators.

As the vulcanizing agents, sulfur is preferably used. The vulcanizing agent content is not particularly limited, but is, per 100 parts by mass of the solid diene rubber, preferably 0.1 to 10 parts by mass, and more preferably 0.5 to 5 parts by mass. In addition, as the vulcanization accelerators, for example, sulfenamide-based, thiuram-based, thiazole-based, guanidine-based, and like various vulcanization accelerators can be mentioned. One of them can be used alone, and it is also possible to use a combination of two or more kinds. The vulcanization accelerator content is not particularly limited, but is, per 100 parts by mass of the solid diene rubber, preferably 0.1 to 7 parts by mass, and more preferably 0.5 to 5 parts by mass.

From the viewpoint of obtaining excellent on-ice braking performance, it is preferable that the rubber composition according to this embodiment has a storage modulus of 20 MPa or less as measured under the conditions of −25° C., a frequency of 10 Hz, a dynamic strain of +0.25%, and a static strain of 10%. Because the lower storage modulus is more preferable from the viewpoint of on-ice braking performance, the lower limit is not particularly set, but may be 10 MPa, for example.

In the case where the dynamic modulus of the rubber composition for a tire tread according to this embodiment is measured under the conditions of a frequency of 10 Hz, a dynamic strain of +0.25%, and a static strain of 10%, from the viewpoint of obtaining excellent on-ice braking performance, the temperature at peak tan δ is preferably −45° C. or less, and more preferably −50° C. or less. In addition, from the viewpoint of obtaining an excellent balance between on-ice braking performance and wet grip performance, the temperature at peak tan δ is more preferably −55° C. to −50° C. In addition, from the viewpoint of obtaining excellent wet grip performance, the value of tan δ at 0° C. is preferably 0.16 or more, and more preferably 0.165 or more. Because the higher tan δ at 0° C. is more preferable from the viewpoint of wet grip performance, the upper limit is not particularly set, but may be 0.24, for example.

The rubber composition according to this embodiment can be made by kneading in the usual manner using a commonly used mixing machine, such as a Banbury mixer, a kneader, or a roll. That is, for example, in the first mixing stage, additives excluding a vulcanizing agent and a vulcanization accelerator are added to a solid diene rubber and mixed, and then, in the final mixing stage, a vulcanizing agent and a vulcanization accelerator are added to the obtained mixture and mixed, whereby a rubber composition can be prepared.

The rubber composition thus obtained is applicable to the treads of pneumatic tires of various sizes for various uses, including tires for passenger cars, large-sized tires for trucks and buses, and the like. That is, the rubber composition is formed into a predetermined shape in the usual manner, for example, by extrusion, and combined with other parts to make a green tire. Subsequently, the green tire is vulcanization-molded at 140 to 180ºC, for example, whereby a pneumatic tire can be produced.

### EXAMPLES

Hereinafter, examples of the invention will be shown, but the invention is not limited to these examples.

Using a lab mixer, according to the formulation (parts by mass) shown in Table 1 below, first, in the first mixing stage, ingredients excluding sulfur and vulcanization accelerators were added to a solid diene rubber and kneaded (discharge temperature=160° C.). Next, in the final mixing stage, sulfur and vulcanization accelerators were added to the obtained kneaded product and kneaded (discharge temperature=90° C.), thereby preparing a rubber composition. The details of the components in Table 1 are as follows.
NR: RSS #3
BR: “BR150B” manufactured by Ube Industries, Ltd.
Silica: “Nipsil AQ” manufactured by Tosoh Silica Corporation
Silane coupling agent: “Si-75” manufactured by Evonik
Carbon black: “SEAST KH” manufactured by Tokai Carbon Co., Ltd.
Zinc oxide: “Zinc Oxide, Type 2” manufactured by Mitsui Mining & Smelting Co., Ltd.
Stearic acid: “Beads Stearic Acid” manufactured by NOF Corporation
Wax: “OZOACE-1722” manufactured by Nippon Seiro Co., Ltd.
Antioxidant: “NOCRAC 6C” manufactured by Ouchi Shinko Chemical Industrial Co., Ltd.
Oil: “Process P200” manufactured by ENEOS Corporation
Hydrocarbon-based resin 1: C5/C9-based resin, “Petrotack 90” manufactured by Tosoh Corporation, softening point=100° C.
Hydrocarbon-based resin 2: Terpene-based resin, “SYLVATRAXX 4150” manufactured by Kraton Corporation, softening point=115° C.
Modified liquid BR: “RICON 603” manufactured by Cray Valley, modifying group=alkoxysilane, weight average molecular weight (Mw)=2,500, number average molecular weight (Mn)=1,700, molecular weight (Mw/Mn)=1.5
Vulcanization accelerator 1: “SOXINOL CZ” manufactured by Sumitomo Chemical Co., Ltd.
Vulcanization accelerator 2: “NOCCELER DZ” manufactured by Ouchi Shinko Chemical Industrial Co., Ltd.
Sulfur: “Powder Sulfur” manufactured by Tsurumi Chemical Industry Co., Ltd.

Each obtained rubber composition was vulcanized at 160ºC for 20 minutes to make a test piece having a predetermined shape, and subjected to a dynamic viscoelasticity test. In addition, using each obtained rubber composition, a pneumatic tire was made and evaluated for on-ice braking performance. The measurement methods are as follows.
On-Ice Braking Performance: A studless tire applying the above rubber composition to the tread was installed on a 2,000-cc 4WD vehicle. At a temperature of −2° C. to −6° C., ABS was activated from a speed of 40 km/h, and the braking distance on ice was measured (average of n=10). The reciprocal of the measured braking distance was expressed as an index taking Comparative Example 1 as 100. The larger the index, the shorter the braking distance, indicating better on-ice braking performance.
Storage Modulus at −25° C. (E′ (−25)): Using a viscoelasticity measuring machine manufactured by GABO, the storage modulus of a test piece with a thickness of 2 mm and a width of 5 mm was measured under the following conditions: deformation mode: tension, grip interval: 20 mm, temperature: −25° C., frequency: 10 Hz, dynamic strain: +0.25%, static strain: 10%. Table 1 shows each measured value, as well as the index of the reciprocal of the measured value taking Comparative Example 1 as 100. A smaller measured value (larger index) indicates better on-ice braking performance.
Tan δ at 0° C.: Using a viscoelasticity tester manufactured by GABO, the loss coefficient tan δ of a test piece with a thickness of 2 mm and a width of 5 mm was measured under the following conditions: deformation mode: tension, grip interval: 20 mm, frequency: 10 Hz, dynamic strain: 1%, static strain: 10%, temperature: 0° C. The result was expressed as an index taking the value in Comparative Example 1 as 100. A larger index indicates better wet grip performance.
Temperature at Peak Tan δ: Using a viscoelasticity tester manufactured by GABO, the dynamic modulus of a test piece with a thickness of 2 mm and a width of 5 mm was measured under the following conditions: deformation mode: tension, grip interval: 20 mm, frequency: 10 Hz, dynamic strain: +0.25%, static strain: 10%. The temperature at which the loss coefficient tan δ exhibited a peak was determined.

TABLE 1

| | Comp. | Comp. | Comp. | Comp. | Comp. | | |
|---|---|---|---|---|---|---|---|
| | Ex. 1 | Ex. 2 | Ex. 3 | Ex. 4 | Ex. 5 | Ex. 1 | Ex. 2 |
| NR | 50 | 50 | 50 | 50 | 50 | 50 | 50 |
| BR | 50 | 50 | 50 | 50 | 50 | 50 | 50 |
| Silica | 33 | 33 | 33 | 60 | 60 | 60 | 60 |
| Silane coupling agent | 2.8 | 2.8 | 2.8 | 4.2 | 4.2 | 4.2 | 4.2 |
| Carbon black | 35 | 35 | 35 | 8 | 8 | 8 | 8 |
| Zinc oxide | 2 | 2 | 2 | 2 | 2 | 2 | 2 |
| Stearic acid | 2 | 2 | 2 | 2 | 2 | 2 | 2 |
| Wax | 1.5 | 1.5 | 1.5 | 1.5 | 1.5 | 1.5 | 1.5 |
| Antioxidant | 3.8 | 3.8 | 3.8 | 3.8 | 3.8 | 3.8 | 3.8 |
| Oil | 18 | 13 | 14 | 18 | 21 | 17 | 17 |
| Hydrocarbon resin 1 | 5 | 10 | — | 5 | — | 10 | — |
| Hydrocarbon resin 2 | — | — | 10 | — | 1 | — | 10 |
| Modified liquid BR | — | — | — | — | 8 | 8 | 8 |
| Vulcanization accelerator 1 | 0.9 | 0.9 | 0.9 | 0.9 | 0.9 | 0.9 | 0.9 |
| Vulcanization accelerator 2 | 1.1 | 1.1 | 1.1 | 1.1 | 1.1 | 1.1 | 1.1 |
| Sulfur | 1.4 | 1.4 | 1.4 | 1.4 | 1.4 | 1.4 | 1.4 |
| On-ice braking performance | 100 | 93 | 98 | 99 | 101 | — | 107 |
| E′ @ −25° C. | 25.9 | 27.2 | 26.4 | 24.6 | 24.1 | 17.9 | 17.1 |
| E′ @ −25° C. (index) | 100 | 95 | 98 | 105 | 108 | 145 | 152 |
| Tan δ @ 0° C. | 0.167 | 0.182 | 0.189 | 0.169 | 0.138 | 0.167 | 0.169 |
| Tan δ @ 0° C. (index) | 100 | 109 | 113 | 101 | 83 | 100 | 101 |
| Temperature at peak tan δ | −55 | +53 | −49 | +53 | −57 | −54 | −51 |

The results are as shown in Table 1. Comparative Examples 2 and 3 are examples of increasing the resin content from Comparative Example 1. Compared to Comparative Example 1, the wet grip performance improved, but the on-ice braking performance deteriorated.

Comparative Example 4 is an example of increasing the silica content from Comparative Example 1. Compared to Comparative Example 1, the value of storage modulus E′ improved, but there was no improving effect on on-ice braking performance.

Comparative Example 5 is an example of incorporating a modified liquid BR in place of the hydrocarbon-based resin in the formulation of Comparative Example 4. Compared to Comparative Example 4, the wet grip performance significantly deteriorated.

Example 1 is an example of incorporating a hydrocarbon-based resin into the formulation of Comparative Example 5, while Example 2 is an example of changing the kind of resin from Example 1. In Example 2, the on-ice braking performance improved while maintaining the wet grip performance. Although the on-ice braking performance deteriorated due to the increase in the amount of resin in Comparative Examples 2 and 3, in Example 2, the on-ice braking performance improved compared to Comparative Example 5; this confirmed that there was a synergistic effect from the combined use of silica, resin, and liquid BR.

Incidentally, although the on-ice braking performance was not measured in Example 1, because the value of storage modulus E′ improved to the same extent as in Example 2, it can be inferred that similarly to Example 2, the on-ice braking performance improved while maintaining the wet grip performance.

The rubber composition of the invention can be used as a rubber composition for various tires for passenger cars, light trucks, buses, and the like.

What is claimed is:

1. A rubber composition for a tire tread, comprising, per 100 parts by mass of a solid diene rubber including 45 to 55 parts by mass of an isoprene-based rubber and 45 to 55 parts by mass of a butadiene rubber:
50 parts by mass or more of silica;
7 to 20 parts by mass of a hydrocarbon-based resin; and
5 to 20 parts by mass of a modified liquid butadiene rubber.

2. The rubber composition for a tire tread according to claim 1, wherein the modified liquid butadiene rubber is a silane-modified liquid butadiene rubber.

3. The rubber composition for a tire tread according to claim 1, wherein the hydrocarbon-based resin is at least one member selected from the group consisting of a styrene-based resin, a terpene-based resin, a petroleum-based hydrocarbon resin, and a rosin-based resin.

4. The rubber composition for a tire tread according to claim 2, wherein the hydrocarbon-based resin is at least one member selected from the group consisting of a styrene-based resin, a terpene-based resin, a petroleum-based hydrocarbon resin, and a rosin-based resin.

5. The rubber composition for a tire tread according to claim 1, having a storage modulus of 20 MPa or less as measured at −25° C.

6. The rubber composition for a tire tread according to claim 2, having a storage modulus of 20 MPa or less as measured at −25° C.

7. The rubber composition for a tire tread according to claim 1, wherein the temperature at peak tan δ is −45° C. or less, and the value of tan δ at 0° C. is 0.16 or more.

8. The rubber composition for a tire tread according to claim 2, wherein the temperature at peak tan δ is −45° C. or less, and the value of tan δ at 0° C. is 0.16 or more.

9. The rubber composition for a tire tread according to claim 5, wherein the temperature at peak tan δ is −45° C. or less, and the value of tan δ at 0° C. is 0.16 or more.

10. A pneumatic tire made using the rubber composition according to claim 1 for a tread.
